(19) United States
(12) Patent Application Publication
(10) Pub. No.: US 2005/0144396 A1
(43) Pub. Date: Jun. 30, 2005

(54) Coalescing disk write back requests

(76) Inventors: Michael K. Eschmann, Lees Summit, MO (US); Jeanna N. Matthews, Massena, NY (US); John I. Garney, Portland, OR (US); Robert J. Royer JR., Portland, OR (US)

Correspondence Address: TROP PRUNER & HU, PC, 8554 KATY FREEWAY, SUITE 100, HOUSTON, TX, 77024, US

(21) Appl. No.: 10/751,258

(22) Filed: Dec. 31, 2003

(51) Int. Cl. G06F 12/00

(52) U.S. Cl. 711/143; 711/144; 711/113

(57) ABSTRACT

Cache write back requests may be coalesced to reduce disk accesses and improve overall system performance in some embodiments of the present invention. Contiguous and non-contiguous data from more than one cache line may be coalesced into a single write back request and written back in one atomic write to the disk drive. This data may also be flushed from the disk cache in one request.

### BACKGROUND

This invention relates generally to using disk caches in connection with disk drive storage devices.

Peripheral devices such as disk drives used in processor-based systems may be slower than other circuitry in those systems. The central processing units and the memory devices in systems are typically much faster than disk drives. Therefore, there have been many attempts to increase the performance of disk drives. However, because disk drives are electromechanical in nature there may be a finite limit beyond which performance cannot be increased.

One way to reduce the information bottleneck at the peripheral device, such as a disk drive, is to use a cache. A cache is a memory location that logically resides between a device, such as a disk drive, and the remainder of the processor-based system, which could include one or more central processing units and/or computer buses. Frequently accessed data resides in the cache after an initial access. Subsequent accesses to the same data may be made to the cache instead of the disk drive, reducing the access time since the cache memory is much faster than the disk drive. The cache for a disk drive may reside in the computer main memory or may reside in a separate device coupled to the system bus, as another example.

Disk drive data that is used frequently can be inserted into the cache to improve performance. Data which resides in the disk cache that is used infrequently can be evicted from the cache. Insertion and eviction policies for cache management can affect the performance of the cache. Performance can also be improved by allowing multiple requests to the cache to be serviced in parallel to take full advantage of multiple devices.

In some cases, information may be taken and stored in the disk cache without immediately updating the information in the disk drive. In a write back policy, information may be periodically written back from the disk drive to the disk storage. Such write backs may occur when the system is idle and such write backs would otherwise not adversely affect performance and during power cycles.

Generally, these write backs are handled in atomic units that correspond to what are called logical block addresses. Logical block addresses are the addressing units utilized by some operating systems to address information on the disk drive. Generally, an operating system may translate a logical block address utilized by software on a computer system into a physical sector address actually utilized on a particular disk drive.

Thus, conventionally, write backs from disk caches to disk drives occur for the information on one cache line at a time. As a result, a relatively large number of disk accesses may be necessary. Of course, the idea of the disk cache from the beginning was to reduce the number of relatively slow disk accesses.

Thus, there is a need for alternate ways of writing back data from disk caches to disk drives.

### BRIEF DESCRIPTION OF THE DRAWINGS

FIG. 1 is a high level depiction of one embodiment of the present invention;

FIG. 2 is a chart showing a hypothetical organization of data for write back requests in accordance with one embodiment of the present invention; and

FIG. 3 is a flow chart for software for implementing one embodiment of the present invention.

### DETAILED DESCRIPTION

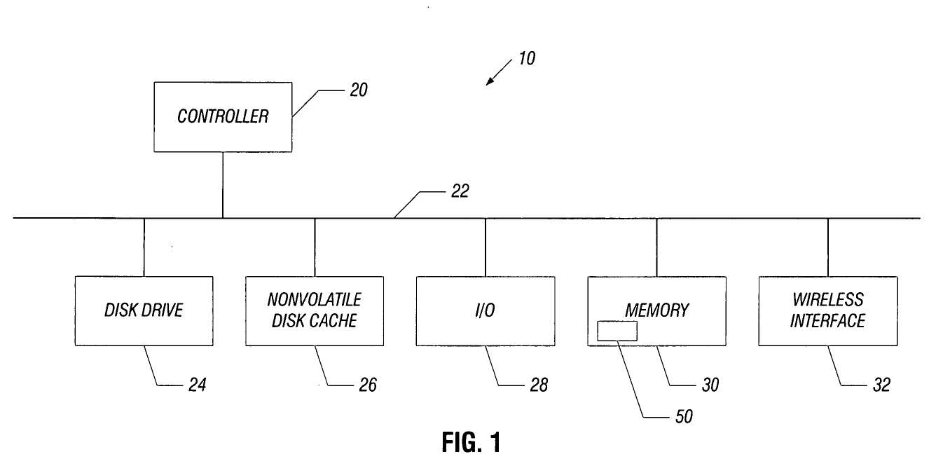

Referring to FIG. 1, a portion of a system 10, in accordance with one embodiment of the present invention, is illustrated. The system 10 may be used in a wireless device such as, for example, a personal digital assistant (PDA), a laptop or portable computer with wireless capability, a web tablet, a wireless telephone, a pager, an instant messaging device, a digital music player, a digital camera, or a desk top computer, to mention a few examples. The system 10 may be used in wireless applications as one example. More particularly, the system 10 may be utilized as a wireless local area network system, a wireless personal area network system, or a cellular network, although the scope of the present invention is in no way limited to wireless applications.

The system 10 may include a controller 20, an input/output (I/O) device 28 (e.g., a keypad, a display), a memory 30, and a wireless interface 32 coupled to each other via a bus 22. It should be noted that the scope of the present invention is not limited to embodiments having any or all of these components.

Also coupled by the bus 22 is a disk cache 26 and a disk drive 24. The disk cache 26 may be any type of non-volatile memory including a static random access memory, an electrically erasable programmable read only memory, a flash memory, a polymer memory such as ferroelectric polymer memory, or an ovonic memory, to mention a few examples. The disk drive 24 may be a magnetic or optical disk drive. The controller 20 may comprise, for example, one or more microprocessors, digital signal processors, microcontrollers, to mention a few examples.

The memory 30 may be used to store messages to be transmitted to or by the system 10. The memory 30 may also be used to store instructions that are executed by the controller 20 during the operation of the system 10, and may be used to store user data. The memory 30 may be provided by one or more different types of memory. For example, the memory 30 may comprise a non-volatile memory.

The I/O device 28 may be used to generate a message. The system 10 may use the wireless interface 32 to transmit and receive messages to and from a wireless communication network with a radio frequency signal. Examples of these wireless interface 32 may include a wireless transceiver or an antenna, such as a dipole antenna, although the scope of the present invention is not limited in this respect.

The system 10 may implement a cache write back policy in which data is flushed or evicted from the non-volatile disk cache 26 and written back to the disk drive 24 upon the occurrence of particular events. A driver 50 for implementing the write back policy may be stored in the memory 30 in one embodiment of the present invention. In general, the write back policy in accordance with some embodiments of the present invention, may reduce the number of accesses to the disk drive 24. The disk drive 24 may be an optical or magnetic disk drive and by reducing disk accesses, access time may be improved. The disk accesses may be reduced by coalescing a number of write back requests into a larger single request that can be implemented on the disk drive 24 in advantageous fashion.

Conventionally, write back requests are handled one cache line at a time. As an example, a cache line may be made up of eight consecutive logical block addresses in one embodiment. However, the inventors of the present invention believe that this policy is unduly restrictive and unnecessarily reduces the performance of the disk drive.

Thus, in some embodiments of the present invention, units, such as logical block addresses, which correspond to more than one cache line may be written back at the same time. Using coalesced write backs may reduce the number of disk accesses and thereby improve disk access time in some embodiments.

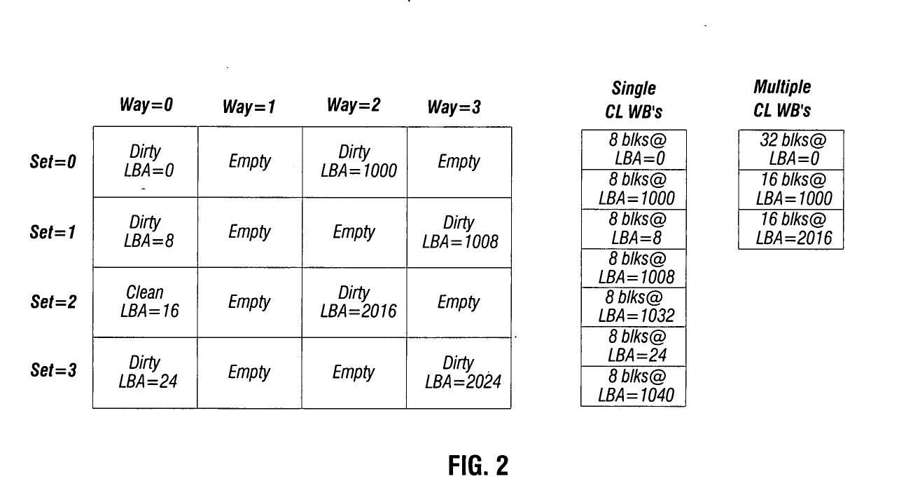

In order to better understand certain aspects of the present invention, a hypothetical organization of a disk storage device is shown in FIG. 2. FIG. 2 is in no way limiting on the present invention, but merely amounts to a hypothetical illustration to demonstrate the operation of some embodiments of the present invention. In this example, the disk drive storage may be arranged in a four-way, set associative organization. Various logical block address regions may be organized in rows called sets 0 through 3 and columns called ways 0 through 3 in the example. Thus, in FIG. 2 (on the left), a dirty logical block address 0 is situated at set 0 way 0. The dirty logical block address 0 may correspond to a cache line with eight consecutive logical block addresses, the first of whose addresses is 0. Similarly, set 0, way 2 may hold a disk cache line whose first logical block address is 1000 and is marked as being dirty. “Dirty” is a term of art that describes data contained in the cache that has not yet been written back to the disk drive.

An implementation of a conventional write back system is indicated as “Single CL WB's” in FIG. 2. Since it is dirty, the cache line at set 0 way 0 would be conventionally written back in one disk access. Next, the cache line in set 0 at way 2 would be written back because it is the next dirty cache line. Then the cache line at set 1 way 0 would be written back, followed by the cache line at set 1 way 3, each a separate write back request. Thereafter, separate write back requests would be created for set 2 way 0, set 2 way 2, set 3 way 0, and set 3 way 3. In order to write the data back, seven separate disk write requests may be implemented in this hypothetical example.

In accordance with one embodiment of the present invention, indicated in FIG. 2 as “Multiple CL WB's,” only three write back requests are utilized. Each way and set may correspond to a single cache line of eight consecutive logical block addresses. The first disk access may write back the dirty cache lines and 32 blocks at set 0 way 0, set 1 way 0, set 2 way 0, and set 3 way 0, in accordance with one embodiment of the present invention. The next write request may include the information in set 0 way 2 and set 1 way 3 which corresponds to 16 blocks. The final write request may include the two lines from set 2 way 2, and set 3 way 3, comprising 16 blocks for a total of three write back requests.

Single cache line disk writes result in several more atomic disk accesses, and the potentially fragmented requests may cause disk seek delays. Coalescing cache line write backs into larger disk cache accesses may result in fewer accesses and less disk seeks.

In accordance with one embodiment of the present invention, the disk accesses are coalesced based on logical block addresses in order to reduce seeks. As a result, the driver 50 builds the write disk accesses so that successive writes occur sequentially on the disk instead of using the set and way arrangement to build write requests. This approach may improve response time of applications by keeping a disk cache cleaner and taking less time to clean the cache in some embodiments of the present invention.

The cache line cleans may span multiple logical block addresses. This approach may utilize the natural rotational characteristics of a cache rotating media drive. The driver 50 also has the ability, in some embodiments, to scan in both directions on the cache. An implementation may have a pointer that starts in the middle of a given set, but may scan in both forward and reverse set number directions in the cache to build a single disk request covering some number of logical block addresses.

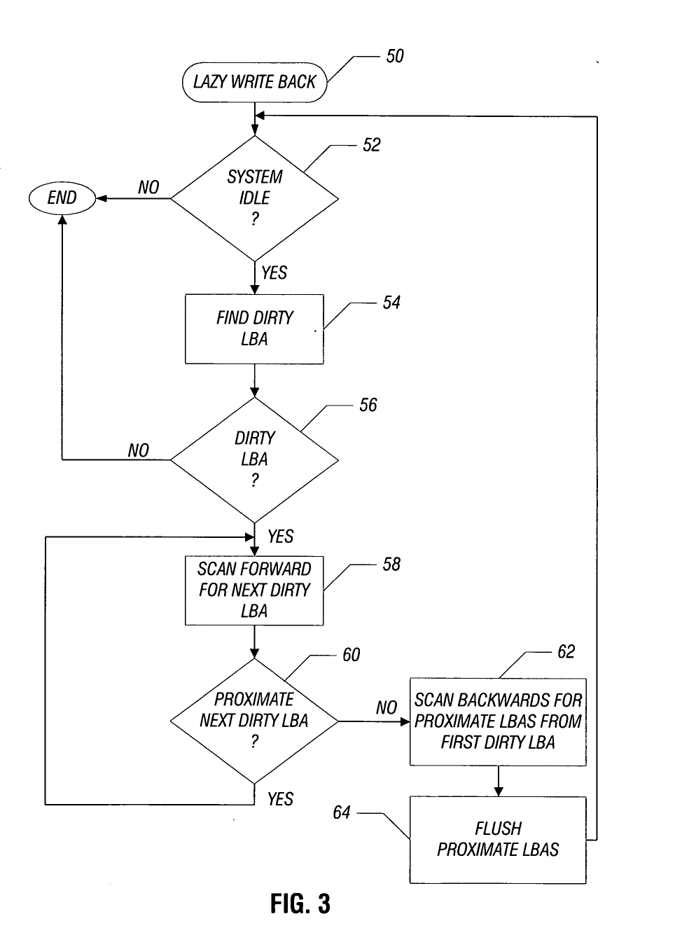

Referring to FIG. 3, the write back driver 50 may be a stand alone piece of code or may be part of some other software, such as a basic input/output system, or an operating system in some embodiments. Initially, a check at diamond 52 determines whether a write back situation has arisen. Namely, a check at diamond 52 may determine whether the system is idle and a write back at this point would not adversely affect the performance of the disk drive subsystem. If the disk drive subsystem can be considered idle, a first dirty logical block address is located in accordance with one embodiment of the present invention as indicated in block 54. In the example shown in FIG. 2, the first logical block address may be the one in the cache line that starts with the logical block address 0 at set 0 way 0. In this example, a block of logically addressable data is utilized but, in other embodiments, other logical or physical addressing schemes may be utilized.

Once a dirty logical block address is found, as indicated in diamond 56, the software 50 may scan forward, in one embodiment, for the next dirty logical block address as indicated in block 58. In other words, the system may scan forward within the set that includes the first dirty logical block address from one way to the next successive way looking for the next dirty logical block address. In other embodiments, the software may first scan backwards.

A check at diamond 60 determines whether the next dirty logical block address is sufficiently proximate to the first dirty logical block address. The determination of proximity may be dynamic or fixed. In a dynamic system, proximity may change based on circumstances. Proximity may be dynamic depending on the nature of the idle state, the nature of the disk drive, or the nature of the cache, to mention a few examples. In a static system, the measure of sufficient proximity may be fixed. In any case, a determination is made of whether two logical block addresses are sufficiently proximate that they may be coalesced into one write request. If so, the flow cycles back to look for the next proximate dirty logical block address.

Once there are no more proximate logical block addresses scanning forward as determined in diamond 60, a backward scan may be implemented as indicated in block 62 in one embodiment. In another embodiment, the scanning may be backwards then forwards. The backward scan may begin from the first dirty logical block address that was found in block 54. However, in some embodiments of the present invention, bidirectional scanning may not be utilized.

Once the proximate logical block addresses are located as determined in block 64, those logical block addresses may be written back to the disk drive as one atomic disk request. The entire set of coalesced logical block addresses may be written back from the disk cache to the disk drive. In the course of such coalesced write backs, some clean data may be written back as well in order to reduce disk seek time.

As an example of forward and backward scanning, under a given condition, the forward scanning, in one embodiment of the present invention, may begin at set 1, way 0 in the chart on the left side of FIG. 2. Then as a result of forward scanning the blocks at set 2, way 0 and set 3, way 0 may be identified. Thereafter, backward scanning may identify the dirty information at set 0, way 0. All 64 blocks of dirty information may be the subject of one atomic disk request to write back the data from the cache to the disk drive.

In some embodiments of the present invention, coalesced write back events reduce the time it takes to clean a cache. In some embodiments, due to lower demands on the system to write back disk data, overall system performance may be improved. This may result in significantly faster shutdown times, since shutdowns typically require a coherent cache.

While an example of an associative memory is given herein the present invention is not necessarily so limited. It may apply to any other types of memory including direct mapped memories.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
writing back data from two or more different cache lines in the same write back request to a disk drive.

2. The method of claim 1 including identifying dirty logical data.

3. The method of claim 2 including identifying dirty logical block addresses.

4. The method of claim 1 including flushing different cache lines in the same operation.

5. The method of claim 1 including writing back data from a non-volatile cache.

6. The method of claim 1 including searching for dirty data to write back.

7. The method of claim 6 including searching in a first direction.

8. The method of claim 7 including searching in a second direction opposite the first direction.

9. The method of claim 6 including searching by sets and ways in a cache organized in sets and ways.

10. The method of claim 6 including determining whether two logical blocks of data that are dirty are sufficiently proximate to write them back to the disk drive write back in the same operation.

11. An article comprising a medium storing instructions that, if executed, enable a processor-based system to:
write back data from two or more different cache lines in the write back request to a disk drive.

12. The article of claim 11 further storing instructions that, if executed, enable the processor-based system to identify dirty logical data.

13. The article of claim 12 further storing instructions that, if executed, enable the processor-based system to identify dirty logical block addresses.

14. The article of claim 11 further storing instructions that, if executed, enable the processor-based system to flush different cache lines in the same operation.

15. The article of claim 11 further storing instructions that, if executed, enable the processor-based system to write back data from a non-volatile cache.

16. The article of claim 11 further storing instructions that, if executed, enable the processor-based system to search for dirty data to write back.

17. The article of claim 16 further storing instructions that, if executed, enable the processor-based system to search in a first direction.

18. The article of claim 17 further storing instructions that, if executed, enable the processor-based system to search in a second direction opposite the first direction.

19. The article of claim 16 further storing instructions that, if executed, enable the processor-based system to search by sets and ways in a cache organized in sets and ways.

20. The article of claim 16 further storing instructions that, if executed, enable the processor-based system to determine whether two logical blocks of data that are dirty are sufficiently proximate to write them back to the disk drive in the same write back operation.

21. A system comprising:
a cache;
a disk drive coupled to said cache; and
a controller to write back data from two or more different cache lines in the same write back request to said disk drive.

22. The system of claim 21, said controller to identify dirty logical data.

23. The system of claim 22, said controller to identify dirty logical block addresses.

24. The system of claim 21, said controller to flush different cache lines in the same operation.

25. The system of claim 21, said controller to write back data from a non-volatile cache.

26. The system of claim 21, said controller to search for dirty data to write back.

27. The system of claim 26, said controller to search in a first direction.

28. The system of claim 27, said controller to search in a second direction opposite the first direction.

29. The system of claim 26, said controller to search by sets and ways in a cache organized in sets and ways.

30. The system of claim 26, said controller to determine whether two logical blocks of data that are dirty are sufficiently proximate to write them back to the disk drive in the same write back operation.
